(19) United States
(12) Patent Application Publication
(10) Pub. No.: US 2006/0271634 A1
(43) Pub. Date: Nov. 30, 2006

(54) Method, system, and program for processing a message with dispatchers

(76) Inventors: Laurence Edward England, Morgan Hill, CA (US); Michael Yiupun Kwong, Standford, CA (US); James Rush Rhyne II, Los Gatos, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/139,003

(22) Filed: May 25, 2005

(51) Int. Cl. G06F 15/16

(52) U.S. Cl. 709/206

(57) ABSTRACT

Provided are a method, system, and program for processing a message with dispatchers. A first dispatcher receives a message. The first dispatcher is associated with a first set of criteria. Each criterion in the first set of criteria is associated with one target, and wherein one target comprises a second dispatcher. The first dispatcher processes the message to determine whether there is at least one criterion that the message satisfies. The message is forwarded to the at least one target associated with the at least one determined criterion. The second dispatcher receives the message in response to one determined criterion being associated with the second dispatcher. The second dispatcher is associated with a second set of criteria and each criterion in the second set is associated with one target.

### BACKGROUND OF THE INVENTION

1. Field of the Invention

The present invention relates to a method, system, and program for processing a message with dispatchers.

2. Description of the Related Art

In current computing environments, different applications and components may cooperate and communicate to implement a business function. For instance, a group of enterprise and business servers may run various web applications and services that communicate with each other. However, different applications and components may communicate using different message and event formats, which may prevent the applications from working with one another. Moreover, applications typically forward messages based on a destination address or header of the message as generated by the application, which can be limiting. Message brokers exist that allow more loosely coupled communication between components. However, message queues will need to be set up beforehand, and the components need to be aware of these message queues for the communication to take place.

### SUMMARY

Provided are a method, system, and program for processing a message with dispatchers. A first dispatcher receives a message. The first dispatcher is associated with a first set of criteria. Each criterion in the first set of criteria is associated with one target, and wherein one target comprises a second dispatcher. The first dispatcher processes the message to determine whether there is at least one criterion that the message satisfies. The message is forwarded to the at least one target associated with the at least one determined criterion. The second dispatcher receives the message in response to one determined criterion being associated with the second dispatcher. The second dispatcher is associated with a second set of criteria and each criterion in the second set is associated with one target.

### BRIEF DESCRIPTION OF THE DRAWINGS

FIGS. 1 and 2 illustrate embodiments of components in a computing environment.

FIG. 3 illustrates an embodiment of a dispatch table entry.

FIG. 4 illustrates an embodiment of message content.

FIG. 5 illustrates an embodiment of operations to process a message with one or more dispatchers.

FIG. 6 illustrates an embodiment of operations to have an adapter convert a message being forwarded to a target application.

FIG. 7 illustrates an embodiment of an arrangement and interactions between dispatchers and applications.

### DETAILED DESCRIPTION

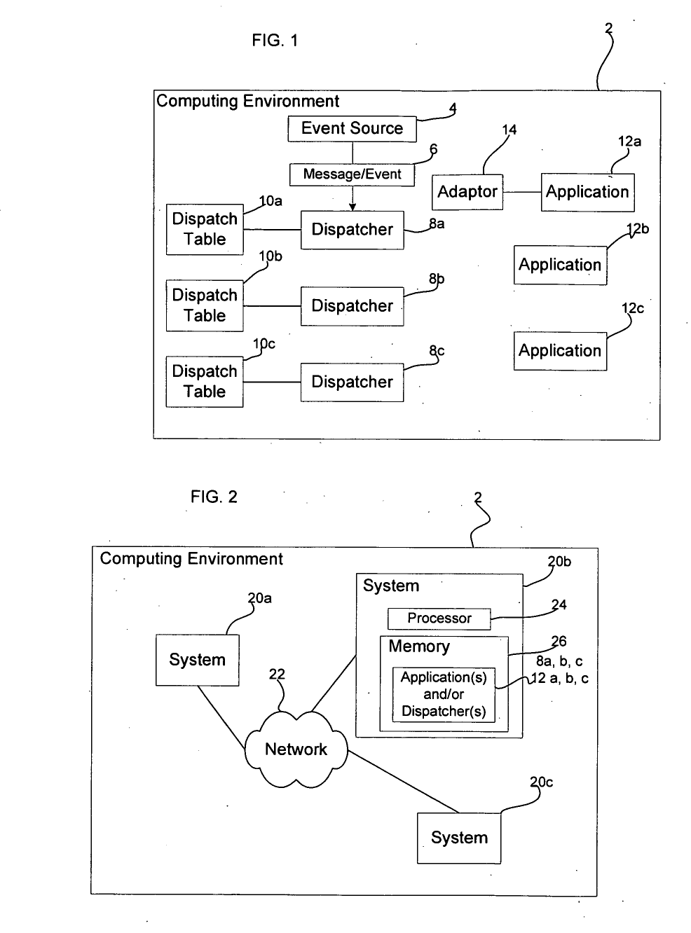

FIG. 1 illustrates a computing environment 2 including an event source 4 that generates an event/message 6 that is sent to a first dispatcher 8a. The first dispatcher 8a may forward a message according to a dispatch table 10a to zero or more specified applications 12a, 12b, 12c or zero or more of additional dispatchers 8b, 8c. Dispatchers 8b, 8c forward a message to an application 12a, 12b, 12c or another dispatcher, such as 8b, 8c or other dispatchers not shown, according to their respective dispatch tables 10b, 10c. Further, if the received message 6 is in a format not understood by the application 12a to which the message 6 is forwarded, then an adaptor 14 associated with the application 12a would translate the forwarded message to and from a format understood by the application 12a. For instance, if the message is in the Simple Object Access Protocol (SOAP), then the message may be forwarded by one dispatcher 8a, 8b, 8c to an application 12a that only supports message in a different format, such as the Java Messaging Service (JMS). (Java is a trademark of Sun Microsystems, Inc.) In such case, the adaptor 16 will convert the message 6 from the format of the event source 4, e.g., SOAP, to a format compatible with the application 10a to which the message is forwarded, such as JMS.

FIG. 2 illustrates the hardware components of a network computing environment 2 in which the components, e.g., dispatchers 8a, 8b, 8c, applications 12a, 12b, 12c and dispatch tables 10a, 10b, 10,c of FIG. 1 may be implemented. A plurality of systems 20a, 20b, 20c communicate via a network 22. Each system 20a, 20b, 20c may include any number of applications 12a, 12b, 12c and/or dispatchers 8a, 8b, 8c. As shown with respect to system 20b, each system may include a processor 24 and a memory 26 in which one or more applications 12a, 12b, 12c and/or dispatchers 8a, 8b, 8c are loaded and run. In an alternative embodiment, all the components, e.g., dispatchers 8a, 8b, 8c, applications 12a, 12b, 12c and dispatch tables 10a, 10b, 10,c of FIG. 1 may be implemented in a single system or enclosure and communicate via shared memory.

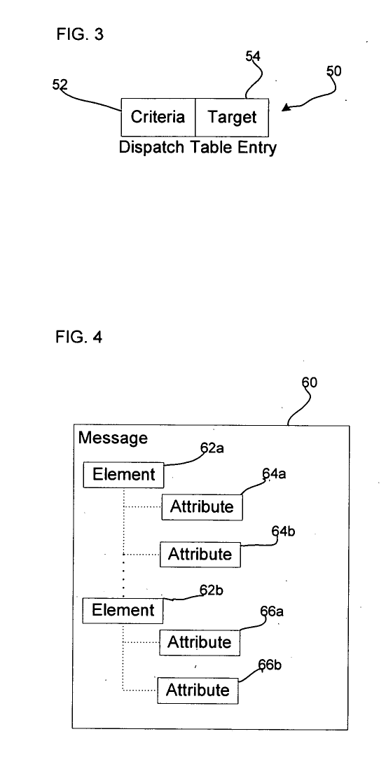

FIG. 3 illustrates an embodiment of an entry 50 in any of the dispatch tables 10a, 10b, 10c, including a criteria 52 and a target 54. The criteria indicates a condition or query, such that if the message content, headers, and/or attributes satisfy the criteria, e.g., condition or query, then that message is forwarded to the indicated target 54, where the target may comprise an application 12a, 12b, 12c, another dispatcher 8a, 8b, 8c, a device, etc. In this way, dispatchers may be arranged in a hierarchical fashion such that parent dispatchers forward messages to child dispatchers if the message satisfies the criteria associated with the target. Further, with the described embodiments, a message is processed according to a hierarchical tree structure, where at each level of the hierarchy, a dispatcher determines whether the message satisfies the criterion associated with each target registered with the dispatcher, i.e., the criterion in the dispatch table 10a, 10b, 10c entries. Yet further, the designer of the hierarchical arrangement of dispatchers may partition events and messages into logical subsets, by having different sets of dispatchers handle each event or message subset, as specified by the criteria or matching rule associated with the dispatchers (and their parents).

FIG. 4 illustrates an embodiment of the message 6 in the form of a structured document 60. Message 60 has one or more elements 62a . . . 62n and each element has zero or more attributes 64a . . . . 64n and 66a . . . . 66n. In this way, the message 60 comprises a hierarchical arrangement of elements 62a . . . 62n, where each element may provide a type of information and attributes of that element providing properties of the element content. Elements and attributes may be delimited by start and end tags, or for empty elements an empty element tag, with the content, name or other information between the start and end tags. For instance, message 60 may have elements providing the content of the message and other elements and attributes providing additional information and properties about the message, such as the source, target application for which the message is intended, source application that generated the message, etc. The message 60 may comprise an Extensible Markup Language (XML) document. Details of the XML language are described in the publication “Extensible Markup Language (XML) 1.0 (Third Edition)” (Copyright W3C, 2004).

In one embodiment, the criteria 52 may comprise a query that searches the content of the message to determine if the content satisfies certain conditions. The criteria may be expressed using a query language, (such as XPath or XQuery, for messages represented as an XML document or an XML InfoSet). The query criteria may examine the content of the message, or other attributes such as the source application or user that generated the message, the target application or user intended to receive the message, a time, date or priority associated with the message to determine one or more targets to which the message is forwarded. Details of the XQUERY language are described in the publication “XQuery 1.0: An XML Query Language”, Working Draft No. 11 (Copyright W3C, February 2005); details of XPath are described in the publication “XML Path Language (XPath), Version 1.0” (Copyright W3C, 1999). Details of XML InfoSet are described in the publication “XML Information Set (Copyright W3C, 2d Ed., 2004). For instance, the query criteria may examine the content of the message, or other attributes such as the source application or user that generated the message, the target application or user intended to receive the message, a time, date or priority associated with the message to determine one or more targets to which the message is forwarded.

Because a dispatch table 10a, 10b, 10c may have multiple entries, the message 60 may be processed to determine whether it satisfies multiple criteria 52. For each criterion 52 satisfied, the message 6, 60 would be forwarded to the dispatcher 8a, 8b, 8c or application 12a, 12b, 12c identified as the target. This allows multiple applications or targets to register interest in a particular class of events. In embodiments where the message 60 comprises an XML structured document, the criteria 54 may comprise an XQUERY that queries the message 6, 60 to determine whether any XML elements and/or attributes that satisfy the conditions of the query specified by the XQUERY expression.

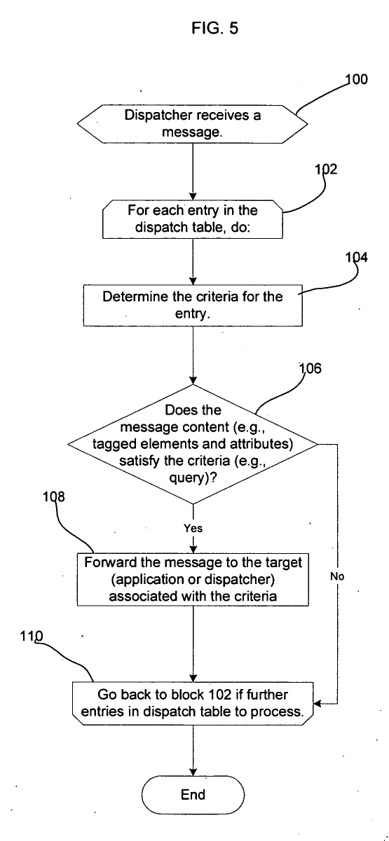

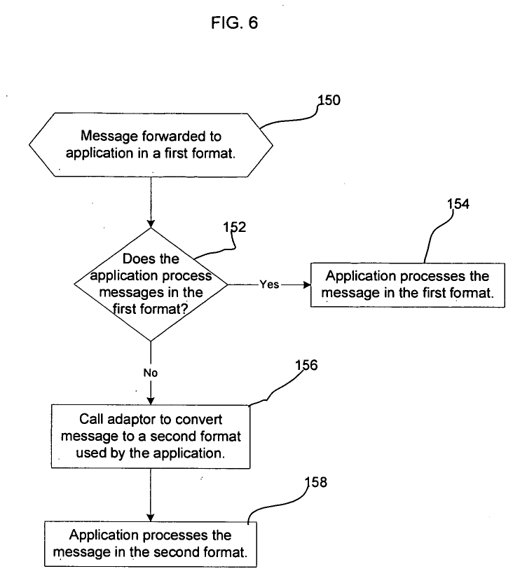

FIG. 5 illustrates operations performed by a dispatcher 8a, 8b, 8c in response to receiving a message 6, 60 from the event source 4 or another dispatcher 8a, 8b, 8c. The event source 4 may comprise an application 12a, 12b, 12c. Upon one dispatcher 8a, 8b, 8c receiving (at block 100) the message 6, the dispatcher 8a, 8b, 8c performs the operations at blocks 102 through 110 for each entry 50 in the dispatch table 10a, 10b, 10c associated with the receiving dispatcher 8a, 8b, 8c. The dispatcher 8a, 8b, 8c determines (at block 104) the criteria 52 for the entry 50 being processed. If (at block 106) the message content (e.g., content in any element 62a, 62n and/or attribute 64a . . . 64n, 66a . . . 66n) satisfies the criteria 52, i.e., satisfies the XQUERY if the message 60 comprises an XML document, then the message 6, 60 is forwarded (at block 108) to the target 54 (application 12a, 12b, 12c or dispatcher 8a, 8b, 8c) associated with the criteria 52, which is the target 54 identified in the entry 50 being processed. After forwarding the message 6, 60 (at block 108) or if (at block 106) the message 6 does not satisfy the criteria 52, then control proceeds back to block 102 to process a next entry 50 in the dispatch table 10a, 10b, 10c. After processing all entries 50 in the dispatch table 10a, control ends. If the message is forwarded to another dispatcher, i.e., a child dispatcher, then that child dispatcher would perform the operations of FIG. 5 to process the message.

In one embodiment, the dispatcher 8a, 8b, 8c may sequentially process the dispatch table 10a, 10b, 10c entries and forward the message to the target 54 associated with each satisfied criteria 52. This allows multiple applications or targets to register interest in a particular class of events. In an alternative embodiment, after finding one criteria 52 in one entry that the received message satisfies, the dispatcher 8a, 8b, 8c may cease processing any subsequent entries in the dispatch table 10a, 10b, 10c, so that the message is forwarded to only the target associated with the first satisfied criteria. In another alternative embodiment, the criteria matching could be done in parallel by multiple processor cores or processors to speed up the processing.

FIG. 6 illustrates an embodiment of operations performed when the message 6 is in a first format that is not compatible with a second format used by the application 12a, 12b, 12c. Upon forwarding (150) a message 6, 60, if (at block 152) the application is capable of processing messages in the first format used by the event source 4, then the target application 12a, 12b, 12c processes (at block 154) the message 6, 60 in the first format. Otherwise, if the first format is not compatible with the target application 12a, 12b, 12c, then an adaptor 14 is called (at block 156) to convert the message 6, e.g., in XML, to a second format, e.g., JMS, used by the application 12a, 12b, 12c. In one embodiment, the dispatcher 8a, 8b, 8c may call the adaptor 14. In another embodiment, the application 12a, 12b, 12c may call the adaptor 14. Further, the adaptor 14 may be part of the dispatcher in order to convert the message to the proper format before forwarding to the application. The application 12a, 12b, 12c processes (at block 158) the converted message in the compatible format. Similarly, an adapter 14 can be placed between the event source 4 and the first dispatcher 8a to convert an alternative message type into the canonical format that the dispatchers 8a, 8b, 8c are designed to handle. In this manner, different message types can be handled, while at the same time, the dispatch system be kept simple and focus on a single message type.

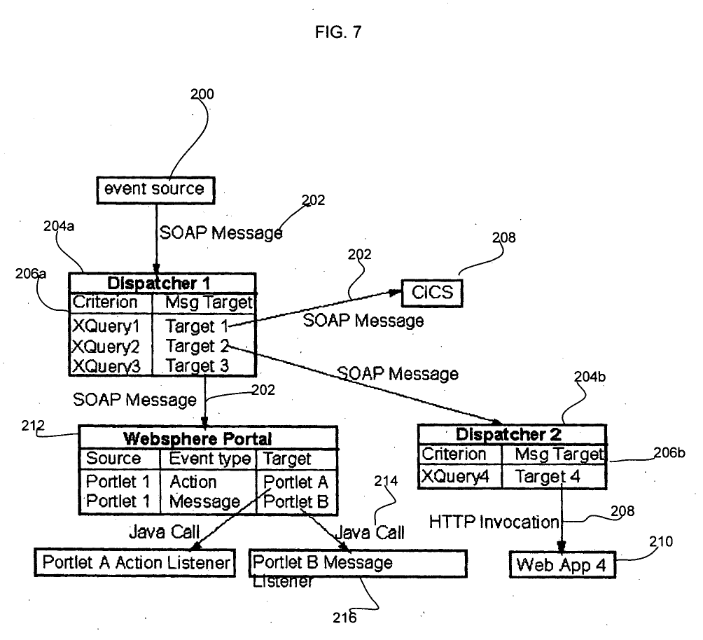

FIG. 7 illustrates one embodiment of a dispatch environment. An event source 200 forwards a SOAP message 202 to a first dispatcher 204a having a dispatch table 206a of three XQUERY/target entries. For instance, satisfying XQUERY1 will result in the message 202 being forwarded to a Customer Information Control System (CICS) 208, which is an application server that provides industrial-strength, online transaction management and connectivity for mission-critical applications. If the message 202 satisfies XQUERY2, then the message is forwarded to a second dispatcher 204b having a dispatch table 206b with one entry having XQUERY4. If the SOAP message 202 satisfies XQUERY4, then the second dispatcher 206b converts the message to a Hypertext Transport Protocol (HTTP) invocation 208 that is sent to a web application 210.

At the first dispatcher 204a, if the message 202 satisfies the XQUERY3, then the SOAP message 202 is sent to a WebSphere® portal application 212, which provides an access point to a Web application. (WebSphere is a registered trademark of International Business Machines, Corp.). A portal is a reusable component that provides access to applications, web-based content, and other resources. Web pages, web services, applications, and syndicated content feeds can be accessed through a portal. The WebSphere portal 212 converts the message 202 to a Java call 214 and forwards the message 6 to a portlet 216. In summary, the message will be forwarded to the components and applications based on a set of criteria used by the chain of dispatchers to select applications and components to receive the message. For example, according to FIG. 7, a message satisfying both XQuery2 and XQuery4 in dispatchers 204a and 204b is forwarded to “Web App 4” 210. Depending on how the system is set up, the message can be forwarded to all the components that match the message, or the first component that is found.

Described embodiments provide a methodology for creating a hierarchical arrangement of dispatchers to allow a message to be processed by the hierarchically arranged dispatchers based on the message content and forward the message to an application associated with the content.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in a medium, where such medium may comprise hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a one or any number of devices/articles may be used in place of the more than one illustrated device or article.

The functionality and/or the features of a device may be alternatively embodied by one or more other devices which are not explicitly described as having such functionality/features. Thus, other embodiments of the present invention need not include the device itself.

In FIGS. 5 and 6, certain operations were described as performed by a configuration method or a device driver. In alternative embodiments, certain operations described as performed by the configuration method may be performed by the device driver and operations described as performed by the device driver may be performed by the configuration method.

In described embodiments, the target associated with a criteria in a dispatch table entry comprises an application or another dispatcher. In additional embodiments, the target may comprise an Input/Output (I/O) device, such as a printer, storage device, transmission, etc.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
receiving a message at a first dispatcher, wherein the first dispatcher is associated with a first set of criteria, wherein each criterion in the first set of criteria is associated with one target, and wherein one target comprises a second dispatcher;
processing, by the first dispatcher, the message to determine whether there is at least one criterion that the message satisfies;
forwarding the message to the at least one target associated with the at least one determined criterion; and
receiving the message at the second dispatcher in response to one determined criterion being associated with the second dispatcher, wherein the second dispatcher is associated with a second set of criteria, wherein each criterion in the second set is associated with one target.

2. The method of claim 1, wherein the first and second set of criteria define queries that query content of the message, wherein the message satisfies one criterion if the message satisfies the query defined by the criterion.

3. The method of claim 2, wherein the query considers all the content of the message.

4. The method of claim 2, wherein the message comprises a structured document having tagged elements and attributes, and wherein the query determines if the tagged elements and attributes of the message satisfy the query.

5. The method of claim 4, wherein the structured document comprises an Extensible Markup Language (XML) document and wherein the query comprises an XQuery or XPath that queries the tagged elements and attributes of the message to determine if the message satisfies a criteria.

6. The method of claim 2, wherein the first and second set of criteria are implemented in a first and second tables, respectively, wherein each entry in the first and second tables includes one criterion and the target associated with that criterion, wherein the target comprises one of an application or a dispatcher.

7. The method of claim 1, wherein one target associated with one dispatcher criterion comprises an application or software component to which the message is directed that is capable of processing the message.

8. The method of claim 7, wherein a first application program generates the received message in a first message format, wherein the target to which the message is forwarded comprises a second application program processing messages in a second message format, further comprising:
converting the message from the first message format to the second message format, wherein the converted message is forwarded to the second application program.

9. The method of claim 1, wherein processing, by one dispatcher, the message to determine at least one criterion that the message satisfies comprises processing each criterion associated with the dispatcher, wherein the message is forwarded to each target, including an application target or dispatcher target, associated with one criterion that the message satisfies.

10. A system, comprising:
at least one target;
a first dispatcher;
a second dispatcher;
a first set of criteria associated with the first dispatcher, wherein each criterion in the set of criteria is associated with one target, and wherein one target comprises a second dispatcher;
a second set of criteria associated with the second dispatcher, wherein each criterion associated with the second dispatcher is associated with one target;
wherein the first dispatcher is executed to perform operations, the operations comprising:
receiving a message;
processing the message to determine whether there is at least one criterion that the message satisfies;
forwarding the message to the at least one target associated with the at least one determined criterion; and
wherein the first dispatcher is executed to perform operations, the operations comprising receiving the message in response to one determined criterion of the first set of criteria being associated with the second dispatcher.

11. The system of claim 10, wherein the first and second set of criteria define queries that query content of the message, wherein the message satisfies one criterion if the message satisfies the query defined by the criterion.

12. The system of claim 11, wherein the query considers all the content of the message.

13. The system of claim 11, wherein the message comprises a structured document having tagged elements and attributes, and wherein the query determines if the tagged elements and attributes of the message satisfy the query.

14. The system of claim 13, wherein the structured document comprises an Extensible Markup Language (XML) document and wherein the query comprises an XQuery or XPath that queries the tagged elements and attributes of the message to determine if the message satisfies a criteria.

15. The system of claim 11, wherein the first and second set of criteria are implemented in a first and second tables, respectively, wherein each entry in the first and second dispatcher table includes one criterion and the target associated with that criterion, wherein the target comprises one of an application or a dispatcher.

16. The system of claim 10, wherein one target associated with one dispatcher criterion comprises an application or software component to which the message is directed that is capable of processing the message.

17. The system of claim 16, further comprising:
a first application program generating the received message in a first message format;
a second application program processing messages in a second message format, wherein the target to which the message is forwarded comprises the second application program; and
an adaptor for converting the message from the first message format to the second message format, wherein the converted message is forwarded to the second application program.

18. The system of claim 10, wherein processing, by one dispatcher, the message to determine at least one criterion that the message satisfies comprises processing each criterion associated with the dispatcher, wherein the message is forwarded to each target, including an application target or dispatcher target, associated with one criterion that the message satisfies.

19. An article of manufacture including code implementing a first and second dispatchers, wherein the code is in communication with at least one target, and wherein the code is capable of causing the first and second dispatchers to perform operations, the operations comprising:
receiving a message, by the first dispatcher, wherein the first dispatcher is associated with a first set of criteria, wherein each criterion in the first set of criteria is associated with one target, and wherein one target comprises a second dispatcher;
processing, by the first dispatcher, the message to determine whether there is at least one criterion that the message satisfies;
forwarding, by the first dispatcher, the message to the at least one target associated with the at least one determined criterion; and
receiving the message, by the second dispatcher, in response to one determined criterion being associated with the second dispatcher, wherein the second dispatcher is associated with a second set of criteria, wherein each criterion in the second set is associated with one target.

20. The article of manufacture of claim 19, wherein the first and second set of criteria define queries that query content of the message, wherein the message satisfies one criterion if the message satisfies the query defined by the criterion.

21. The article of manufacture of claim 20, wherein the query considers all the content of the message.

22. The article of manufacture of claim 20, wherein the message comprises a structured document having tagged elements and attributes, and wherein the query determines if the tagged elements and attributes of the message satisfy the query.

23. The article of manufacture of claim 22, wherein the structured document comprises an Extensible Markup Language (XML) document and wherein the query comprises an XQuery or XPath that queries the tagged elements and attributes of the message to determine if the message satisfies a criteria.

24. The article of manufacture of claim 22, wherein the first and second set of criteria are implemented in a first and second tables, respectively, wherein each entry in the first and second tables includes one criterion and the target associated with that criterion, wherein the target comprises one of an application or a dispatcher.

25. The article of manufacture of claim 21, wherein one target associated with one dispatcher criterion comprises an application or software component to which the message is directed that is capable of processing the message.

26. The article of manufacture of claim 25, wherein the code is in communication with a first application program that generates the received message in a first message format, wherein the target to which the message is forwarded comprises a second application program processing messages in a second message format, wherein the code further implements an adaptor, wherein the operations further comprise:
converting, by the adaptor, the message from the first message format to the second message format, wherein the converted message is forwarded to the second application program.

27. The article of manufacture of claim 19, wherein processing, by one dispatcher, the message to determine at least one criterion that the message satisfies comprises processing each criterion associated with the dispatcher, wherein the message is forwarded to each target, including an application target or dispatcher target, associated with one criterion that the message satisfies.
